(19) United States
(12) Patent Application Publication
(10) Pub. No.: US 2014/0047812 A1
(43) Pub. Date: Feb. 20, 2014

(54) Lawn Mower Wheel and Lawn Mower with such a Wheel

(71) Applicants: Jörgen Johansson, Jonkoping (SE); Mikael Adolfsson, Granna (SE); Magnus Henriksson, Jonkoping (SE); Jasmin Insanic, Jonkoping (SE); Jonas Tibbelin, Huskvama (SE); Fredrik Edholm, Jonkoping (SE); Helena Forsberg, Bankeryd (SE)

(72) Inventors: Jörgen Johansson, Jonkoping (SE); Mikael Adolfsson, Granna (SE); Magnus Henriksson, Jonkoping (SE); Jasmin Insanic, Jonkoping (SE); Jonas Tibbelin, Huskvama (SE); Fredrik Edholm, Jonkoping (SE); Helena Forsberg, Bankeryd (SE)

(73) Assignee: HUSQVARNA AB, Huskvarna (SE)

(21) Appl. No.: 14/113,833

(22) PCT Filed: Apr. 27, 2011
(86) PCT No.: PCT/SE2011/050511

§ 371 Date: Oct. 25, 2013

(51) Int. Cl. B60B 3/00; A01D 34/82

(52) U.S. Cl. CPC B60B 3/00; A01D 34/82
USPC 56/16.7; 301/63.101; 180/19.1

(57) ABSTRACT

A lawn mower wheel (2) is provided. The lawn mower wheel (2) comprises a hub (3) arranged for attachment to a lawn mower wheel axle extending in an axial direction. The lawn mower wheel (2) comprises a tread (4). The tread (4) has a tread width (8) in the axial direction. The tread is a web structure of material portions (6) separated by through openings (7) to reduce the area of the tread (4) onto which grass clippings may attach. The lawn mower wheel (2) comprises a rim (5). The rim (5) extends from the hub (3) to the tread (4). The rim (5) has a rim width (9) in the axial direction. The rim width (9) corresponds to less than half of the tread width (8), to allow grass clippings to fall from one through opening (7) of the tread (4) to another.

### TECHNICAL FIELD

Embodiments herein relate to a lawn mower wheel, and to a lawn mower comprising a lawn mower wheel. In particular, embodiments herein relate to a lawn mower wheel for handling grass clippings.

### BACKGROUND

A walk behind lawn mower comprises a chassis, wheels, a handle and a cutting deck onto which a rotating cutting blade is arranged. If the lawn mower is motor driven, it comprises an engine which is arranged to rotate the cutting blade and/or drive one or more of the lawn mower wheels.

The lawn mower wheels are usually arranged pairwise at the front and at the back of the cutting deck, such that the cutting blade is situated between the four wheels. The lawn mower wheels are often made by separate parts such as a rim, a hubcap and a tire. The tire is arranged to contact the lawn during operation of the lawn mower.

During motion of the lawn mower, the cutting blade cuts the grass over which the cutting blade rotates, whereas the grass under the travelling path of the tires will not be cut. Therefore, the lawn mower needs to be moved back and forth along adjacent travelling paths in order to cut all of the grass.

Due to this, the lawn mower wheels will likely be moved over portions of the lawn that have already been cut. This may result in grass clippings and the like sticking to the wheels, and causing problems such as reduced grip of drive wheels, and dirty wheels which are hard to clean. This may impair the functionality of the lawn mower.

### SUMMARY

In view of the discussion above, it is an object for embodiments herein to provide an improved lawn mower wheel.

According to a first aspect, the object is achieved by a lawn mower wheel for handling grass clippings. The lawn mower wheel comprises a hub. The hub is arranged for attachment to a lawn mower wheel axle, which wheel axle extends in an axial direction. The lawn mower wheel further comprises a tread. The tread is arranged to contact the lawn during operation of the lawn mower. The tread has a tread width in the axial direction. The tread is a web structure of material portions separated by through openings to reduce the area of the tread onto which grass clippings may attach. The lawn mower wheel further comprises a rim. The rim extends from the hub to the tread. The rim has a rim width in the axial direction. The rim width corresponds to less than about half of the tread width, to allow grass clippings to fall from one through opening of the tread to another.

In some embodiments, the rim width corresponds to less than about a third of the tread width.

In some embodiments, the material portions cover about 30%-70% of the area of the tread.

In some embodiments, the material portions cover about 40%-60% of the area of the tread.

In some embodiments, the material portions cover about 50% of the area of the tread.

By “area of the tread” is understood the tread circumference multiplied by the tread width. By “tread width” is understood the total width over which the tread extends in the axial direction, or a mean thereof if the tread width is not constant.

Thanks to the web structure, less material is needed for producing the tread, and a reduced area onto which grass clippings may attach is provided. Moreover, the web structure may improve the grip for a drive wheel. The web structure may also allow grass to keep standing up when it is run over by the lawn mower wheel.

According to some embodiments, the web structure comprises at least two material portions which extend essentially in the axial direction, and which are spaced in a tangential direction, to provide load distribution during rotation of the lawn mower wheel.

In some embodiments, the one or more material portions comprise intakes.

This may reduce the risk of grass clippings sticking to the tread, while providing required stability.

According to some embodiments, the intakes are arranged on either side of the through openings in an axial direction.

According to some embodiments, the web structure is arranged to provide through openings shaped as hexagons which are separated in the tangential direction by material portions which are essentially parallel to the axial direction.

According to some embodiments, the rim is a web structure of material portions separated by through openings, to reduce the side area of the wheel onto which grass clippings may attach.

This may render the lawn mower wheel easy to clean, and allows for a design without a hub cap. Moreover, it reduces the required amount of material and reduces the weight of the lawn mower wheel.

According to some embodiments, the lawn mower wheel is formed in one piece.

According to some embodiments, the lawn mower wheel comprises a plastic material.

In some embodiments, the rim is arranged to be situated at a distal end of the tread in the axial direction in relation to a lawn mower chassis when the lawn mower wheel is mounted on the lawn mower.

This may facilitate the attachment of driving mechanisms to the lawn mower wheel if the lawn mower wheel is a drive wheel.

According to a second aspect, the object is achieved by a lawn mower comprising at least one lawn mower wheel according to the first aspect.

In some embodiments, the lawn mower comprises two lawn mower wheels according to the first aspect, which lawn mower wheels are arranged on opposite sides of a chassis of the lawn mower.

According to some embodiments the lawn mower wheels are drive wheels.

Thanks to embodiments herein, wherein the tread is a web structure, grass clippings and the like is less likely to stick to the lawn mower wheel. Moreover, thanks to the rim being arranged to be present over less than half of the tread width, grass clippings or the like entering the wheel volume through the web structure is likely to fall out again.

Other objects, advantages and novel features of embodiments herein will become apparent from the following detailed description when considered in conjunction with the accompanying drawings and claims.

### BRIEF DESCRIPTION OF THE DRAWINGS

FIG. 1 is a schematic perspective view of a lawn mower comprising lawn mower wheels according to embodiments herein.

FIG. 2 is a schematic front view of a lawn mower wheel according to embodiments herein.

FIG. 3 is a schematic perspective view of the lawn mower wheel in FIG. 2.

### DETAILED DESCRIPTION

Embodiments may be exemplified in the following non-limiting description of embodiments.

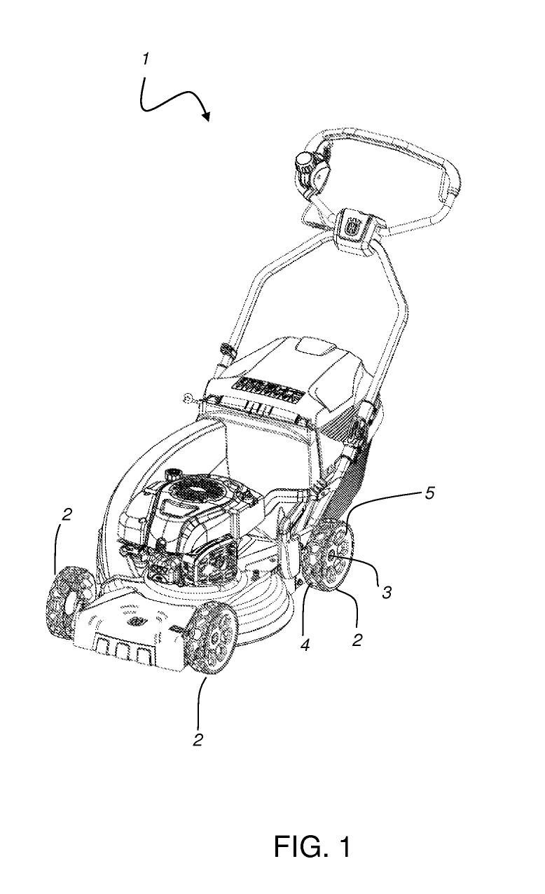

FIG. 1 schematically depicts a lawn mower 1 comprising four lawn mower wheels 2 according to embodiments herein, of which three are seen in the FIG. 1.

The lawn mower wheels 2 each have a hub 3 attached to a wheel axle or the like of the lawn mower 1. Each wheel 2 has a tread 4, arranged to contact the lawn during operation of the lawn mower 1. Each lawn mower wheel 2 further comprises a rim 5. The rim 5 connects the hub 3 to the tread 4, and constitutes the side of the lawn mower wheel 2. The rim may be arranged at the distal end of the lawn mower wheel 2 in relation to the lawn mower 1. This may facilitate attachment of the lawn mower wheel 2 to for example a drive mechanism, or a wheel axle, or the like.

In some embodiments, the rim is arranged in the middle of the lawn mower wheel 2, or at the proximal side of the lawn mower wheel 2.

In some embodiments, the lawn mower 1 comprises two lawn mower wheels 2 According to some embodiments, the lawn mower 1 comprises one or more lawn mower wheels 2 according to embodiments herein, wherein the lawn mower wheels are drive wheels.

During operation of the lawn mower 1, the lawn mower wheels 2 rotate as the lawn mower 1 move, and the treads 4 contact the lawn. As the lawn mower 1 is moved back and forth over a lawn to cut it, grass clippings and the like, such as small plants, or berries and fruit that may be present on the lawn, may be run over by one or more of the lawn mower wheels 2.

Thanks to embodiments herein, wherein the tread 4 is a web structure, grass clippings and the like is less likely to stick to the lawn mower wheel when in contact with the lawn mower wheel 2.

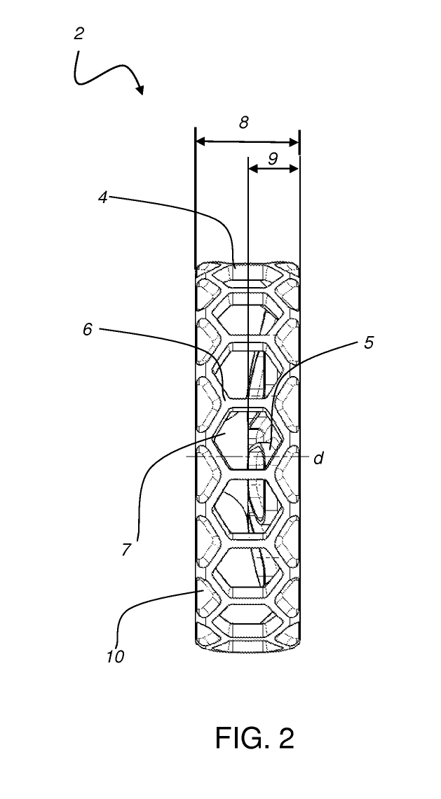

The lawn mower wheels 2 according to embodiments herein will in the following be further described with reference to FIG. 2, which depicts a schematic front view of one lawn mower wheel 2 as those depicted in FIG. 1.

As can be seen in FIG. 2, the tread 4 of the lawn mower wheel 2 is a web structure of material portions 6 which are separated by through openings 7.

The tread 4 has a tread width 8 in an axial direction d. The tread width 8 may in some embodiments be between 35 mm and 65 mm. Wider lawn mower wheels 2 may add extra width to the lawn mower as a whole, which in many cases is undesired.

Further seen in FIG. 2, is that the rim 5 of the lawn mower wheel 2 has a rim width 9 in the axial direction d. The rim width 9 is about half of the tread width 8.

Thanks to this, the rim 5 is present in less than half of the volume defined by the tread 4, i, e in less than half the wheel volume, and grass clippings or the like entering the wheel volume through the web structure is likely to fall out again.

In some embodiments, the rim width 9 is less than a third of the tread width 8. This may further facilitate for grass clippings and the like to fall straight through the lawn mower wheel 2.

The “skeleton”-structure of the lawn mower wheel 2 according to embodiments herein further reduces material costs, and provides a light-weight lawn mower wheel 2 with maintained load distribution capacity. The skeleton structure further facilitates cleaning of the lawn mower wheel 2.

Lawn mower wheels according to embodiments herein may further, thanks to the web structure of the tread 4, allow for the grass along the travelling path of the tread 4, that is the grass that is run over by the lawn mower wheels 2, to keep standing up. Since pressed down, flattened, grass may be difficult to cut, this may improve the cutting function of the lawn mower 1.

In some embodiments, the material portions further comprise intakes 10. This may further reduce the area of the lawn mower wheel 2 onto which grass clippings may attach, whilst providing required stability of the tread 4.

According to some embodiments, the trough openings 7 are shaped as hexagons, which are tangentially separated by material portions 6 that extend in essentially in the axial direction d. Thanks to material portions 6 which are essentially orthogonal to the travelling direction of the lawn mower, a better load distribution may be provided over the tread surface.

In some embodiments, the material portions 6 and the through openings 7 have other shapes, and are arranged in another suitable way.

In some embodiments, the material portions cover about 30%-70% of the area of the tread. In some embodiments, the material portions cover about 40%-60% of the area of the tread. In some embodiments, the material portions cover about 50% of the area of the tread. By “area of the tread” is understood the tread width 8 multiplied by the length of the tread in the tangential direction, i.e. the circumference of the tread.

In some embodiments, the tread pattern, i. e. the web structure, is non-uniform along the tread.

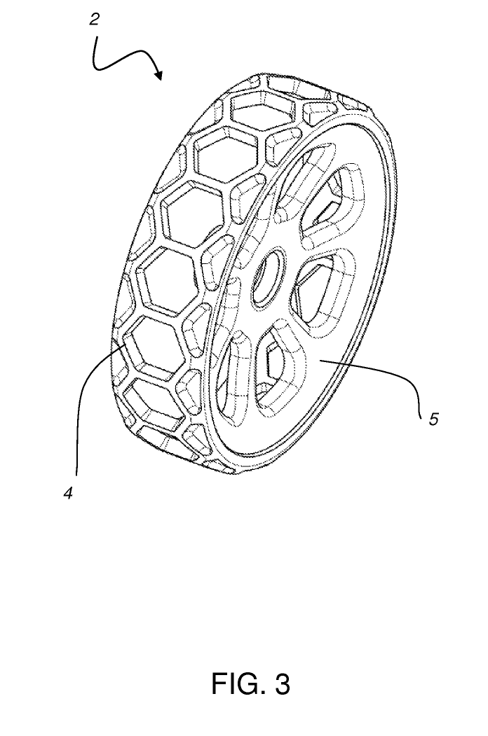

FIG. 3 is a schematic perspective view of the lawn mower wheel 2 depicted in FIG. 2. In this figure, it can be seen that the rim 5 may also be a web structure of material portions separated by through openings. This further reduces the area of the lawn mower wheel 2 onto which grass clippings may attach. Compared to having a rim or hubcap without open regions, less grass is likely to stick to the wheel side with this solution. Such a “skeleton”-structure of the rim 5 may further reduce material costs, and reduce the weight of the lawn mower wheel 2.

As can be seen in FIG. 3, the rim is slightly inclined towards the center of the hub 2, which gives the rim an essentially conical shape. In some embodiments the inclination may be between 0° and 15°. A small inclination provides more free volume inside the lawn mower wheel 2.

In some embodiments, the diameter of the lawn mower wheel 2 is between 120 mm and 280 mm. The inclination of the rim 5 may vary depending on the diameter.

In some embodiments, the lawn mower wheel 2 is made in one piece. In such embodiments, one or more of the hub 3, the tread 4 and the rim 5 previously referred to, may be referred to as a hub portion 2, a tread portion 4 and a tread portion 5.

In some embodiments, the lawn mower wheel 2 comprises, or is made of, a plastic material.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1.-11. (canceled)

12. A lawn mower wheel comprising:
a hub arranged for attachment to a lawn mower wheel axle that extends in an axial direction;
a tread portion having a tread width defined in the axial direction and extending coaxially with an axis of the hub to define a wheel volume, the tread portion being arranged to contact a surface over which the wheel is operable responsive to movement of the lawn mower, the tread portion comprising a web structure of material portions separated by through openings to reduce an area of the tread portion; and
a rim portion extending between the hub and the tread portion, the rim portion being present in less than half of the wheel volume defined by the tread portion.

13. The lawn mower wheel of claim 12, wherein the rim portion comprises a single web structure of material portions separated by through openings.

14. The lawn mower wheel of claim 13, wherein the rim portion and the tread portion are comprised of a single unitary structure.

15. The lawn mower wheel of claim 12, wherein the rim portion defines a rim width in the axial direction, and wherein the rim width corresponds to less than half of the tread width.

16. The lawn mower wheel of claim 15, wherein the rim width corresponds to less than one third of the tread width.

17. The lawn mower wheel of claim 12, wherein the material portions of the tread portion cover between about 30% to about 70% of the area of the tread portion.

18. The lawn mower wheel of claim 12, wherein the web structure of material portions defining the tread portion comprises at least two material portions, the at least two material portions extend substantially in the axial direction, and are spaced apart in a tangential direction to provide load distribution during rotation of the lawn mower wheel.

19. The lawn mower wheel of claim 12, wherein the rim portion comprises a conical structure having an inclination angle of between about 0° and about 15° relative to a direction tangential to the axial direction.

20. The lawn mower wheel of claim 12, wherein the rim portion is arranged to be situated at a distal end of the tread portion in the axial direction, at a proximal end of the tread portion in the axial direction, or in a middle portion of the tread portion in the axial direction.

21. The lawn mower wheel of claim 12, wherein the rim portion is configured within the tread portion such that, over greater than half of the tread width of the tread portion, there is no rim portion disposed between the tread portion and the axis of the hub.

22. A wheeled, outdoor power equipment device comprising:
a chassis;
a handle operably coupled to the chassis;
an engine operably coupled to the chassis; and
a wheel assembly comprising at least one wheel including:
a hub arranged for attachment to a wheel axle that extends in an axial direction;
a tread portion having a tread width defined in the axial direction and extending coaxially with an axis of the hub to define a wheel volume, the tread portion being arranged to contact a surface over which the wheel is operable responsive to movement of the device, the tread portion comprising a web structure of material portions separated by through openings to reduce an area of the tread portion; and
a rim portion extending between the hub and the tread portion, the rim portion being present in less than half of a wheel volume defined by the tread portion.

23. The device of claim 22, wherein the rim portion comprises a single web structure of material portions separated by through openings.

24. The device of claim 23, wherein the rim portion and the tread portion are comprised of a single unitary structure.

25. The device of claim 22, wherein the rim portion defines a rim width in the axial direction, and wherein the rim width corresponds to less than half of the tread width.

26. The device of claim 22, wherein the material portions of the tread portion cover between about 30% to about 70% of the area of the tread portion.

27. The device of claim 22, wherein the web structure of material portions defining the tread portion comprises at least two material portions, the at least two material portions extend substantially in the axial direction, and are spaced apart in a tangential direction to provide load distribution during rotation of the wheel.

28. The device of claim 22, wherein the rim portion comprises a conical structure having an inclination angle of between about 0° and about 15° relative to a direction tangential to the axial direction.

29. The device of claim 22, wherein the rim portion is arranged to be situated at a distal end of the tread portion in the axial direction, at a proximal end of the tread portion in the axial direction, or in a middle portion of the tread portion in the axial direction.

30. The device of claim 22, wherein the rim portion is configured within the tread portion such that, over greater than half of the tread width of the tread portion, there is no rim portion disposed between the tread portion and the axis of the hub.

31. The device of claim 22, wherein the wheel is a drive wheel that receives power from the engine.
